(19) United States
(12) Patent Application Publication
(10) Pub. No.: US 2021/0368370 A1
(43) Pub. Date: Nov. 25, 2021

(54) SPACE UTILIZATION INFORMATION SYSTEM UTILIZING NATIVE LIGHTING CONTROL SYSTEM

(71) Applicant: Hubbell Incorporated, Shelton, CT (US)

(72) Inventors: Christopher Lane Bailey, Greenville, SC (US); William Gerald Felber, Taylors, SC (US); Deborah Michelle Barrett, Piedmont, SC (US)

(21) Appl. No.: 17/323,599

(22) Filed: May 18, 2021

Related U.S. Application Data
(60) Provisional application No. 63/028,303, filed on May 21, 2020.

(51) Int. Cl. H04W 24/08

(52) U.S. Cl. CPC H04W 24/08; H04W 88/16

(57) ABSTRACT

In one embodiment, a gateway device utilizing a gateway to cloud interface may be constructed and arranged to capture the occupancy-detection transmissions of occupancy-detecting connected devices including but not limited to occupancy-detecting light fixtures. The gateway device may process this information in conjunction with a number of other tools and services such as but not limited to a cloud computing service or a data visualization application to provide space utilization information on the basis of the captured occupancy detection transmissions.

### CROSS-REFERENCE TO RELATED APPLICATIONS

The present application claims priority to U.S. Provisional Patent Application No. 63/028,303 “Space Utilization Information System Utilizing Native Lighting Control System,” having a filing date of May 21, 2020, the entire contents of which is incorporated by reference herein.

### FIELD

The present disclosure relates to a system for providing space utilization information.

### BACKGROUND

Space utilization information may be useful to premise-owners for determining where and when occupants spend their time when on-site. Employees, visitors, or occupants may be tracked for purposes advantageous to the respective goals of retailers, public institutions, employers, etc. Space utilization information systems may require the installation and coordination of numerous connected devices such as IoT devices and sensors. However, installing and operating a dedicated space utilization information system may be costly, time consuming, and require frequent maintenance and service calls. Multi-functional devices that provide space utilization information may also inadvertently cause cyber-security issues by requiring direct device polling by a central system, or latency issues by requiring the polling of daisy-chained devices.

### SUMMARY

In one embodiment, a gateway device is constructed and arranged to monitor a transmission of a connected device in a device network. The gateway device includes a memory, a communication interface, and an electronic processor configured to monitor the transmission via the communication interface, determine the protocol of transmission, parse the transmission according to its determined protocol to produce a parsed transmission, update a data model of the device network based on the parsed transmission, and store the data model in the memory.

In one embodiment, a gateway device is used to monitor transmissions between connected devices in a device network. The method utilized includes monitoring, by a communication interface of the gateway device, a transmission of a connected device via the communication interface. The method also comprises determining, by an electronic processor of the gateway device, the transmission to produce a parsed transmission. Additionally, the method comprises parsing, by the electronic processor, the transmission to produce a parsed transmission updating, by an electronic processor, a data model of the device network based on the parsed transmission, and, storing, by the electronic processor, the data model in the memory.

In one embodiment, a transmission monitoring and analysis system comprises a cloud computing system, and a gateway device constructed and arranged to monitor a transmission of a connected device in a device network. The gateway device includes a communication interface and an electronic processor. The electronic processor is configured to monitor the transmission via the communication interface, determine the protocol of transmission, parse the transmission according to its determined protocol to produce a parsed transmission, produce a cloud message based on the parsed transmission, and transmit the cloud message to the cloud computing system.

Other aspects of the disclosure will become apparent by consideration of the detailed description and accompanying drawings.

### BRIEF DESCRIPTION OF THE DRAWINGS

FIG. 1 depicts a hardware schematic for an eavesdropping gateway device.

FIG. 2 depicts a flow diagram for a gateway device eavesdropping on messages transmitted between connected devices.

FIG. 3 depicts a flow diagram for receipt analysis of event and state data by a cloud computing system.

FIG. 4 depicts a flow diagram for capture, processing, and secure communication of connected device transmissions by a gateway device according to a number of embodiments.

FIG. 5 depicts a block diagram for communications between a gateway device and a cloud computing system according to a number of embodiments.

FIG. 6 depicts a schematic plan for data collection, transfer, processing, and organization and storage according to a number of embodiments.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

Further, as used herein “connected” device may refer to a device that is constructed and arranged to communicate with other devices. As a non-limiting example, a connected light fixture may be a light fixture comprising electrical hardware capable of transmitting or receiving data via over-the-air transmission or by electrical communication. Such a device or light fixture may also be equipped with hardware for generating data for transmission such as but not limited to sensor data.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. As used within this document, the word “or” may mean inclusive or. As a non-limiting example, if it were stated in this document that “item Z may comprise element A or B,” this may be interpreted to disclose an item Z comprising only element A, an item Z comprising only element B, as well as an item Z comprising elements A and B.

A plurality of hardware and software-based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input output interfaces, one or more application specific integrated circuits (ASICs), and various connections (for example, a system bus) connecting the various components.

In a number of embodiments, an area may be equipped with a connected device having a sensor for collecting data about their environment. The connected device may be constructed and arranged to deliver and collected data to a remote storage or processing system. The sensor may be included in pre-existing, pre-installed connected devices such as but not limited to lights, light fixtures, electrical outlets, switches or any other connected, occupancy sensing device or infrastructure.

In a number of embodiments, the sensor may be an occupancy sensor. The occupancy sensor may be constructed and arranged to detect human occupancy in a particular manner relative to the sensor. For example, the occupancy sensor may detect occupancy by way of detecting motion, changes in the environment of the sensor such as but not limited to changes in temperature, humidity, or CO₂ levels, detection of changes to audio readings, changes in an infrared spectrum, changes to reflections of ultrasonic or radar patterns, detection of interaction with an object device such as but not limited to a door or a switch by an occupant, and so on. The occupancy sensor may be calibrated to detect only occupancy of a certain type such as but not limited to mammal occupancy, primate occupancy, human occupancy, or employee occupancy. Similarly, the occupancy sensor may be calibrated to disregard occupancy of a certain type such as but not limited to mammal occupancy, primate occupancy, human occupancy, or employee occupancy.

In a number of embodiments, a number of connected devices such as occupancy sensing lights or light fixtures may be connected to one another via a connected port module. Further, groups of connected devices using a port module may be connected to other groups via a connected bridge device. The occupancy sensors may themselves be capable of generating and transmitting occupancy detection data to other devices. The occupancy sensors may transmit occupancy detection data themselves, or via a device connected to the occupancy sensor. Such transmissions may occur over-the-air via wifi, cellular communication, radio frequency, Bluetooth frequency, optical communication, or any other wireless communication protocol. The occupancy sensors may be configured to communicate directly with one another or a central system such as but not limited to a connected device grouping module such as but not limited to a port module, a group inter-communication device such as a bridge device, an area control device, or a cloud computing service. Accordingly, over-the-air firmware updates (OTA) may be achieved for low maintenance headless embedded systems in connected devices. OTA may be facilitated via an IoT hub via a gateway device electrically integrated into, or in wireless communication with the network of connected devices.

In a number of embodiments, the gateway device may be simply placed within capturing range of a network of connected devices, or within capturing range of a connected device communications hub such as but not limited to a port module, a bridge device, an area control device, etc. without needing costly and time consuming electrical integration of the gateway into the ecosystem of connected devices. The gateway device may be used to monitor the transmissions of the connected devices without affecting the receipt of transmissions by recipient connected devices.

In a number of embodiments, a gateway device may be constructed and arranged to facilitate secure remote management of the gateway device to reduce service turnaround time as well as service calls and downtime. A cloud computing system may provide a number of device management functions for the gate device as well as other connected devices such as but not limited to a connected, occupancy sensing light fixture or light. A list of possible remote device management functions may include reboot, factory reset, over-the-air update, enable capture of connected device transmissions, disable capture of connected device transmissions, set connected device state period, get connected device configuration, get gateway configuration.

In number of embodiments, a gateway device utilizing a gateway to cloud interface may be constructed and arranged to capture the occupancy-detection transmissions of occupancy-detecting connected devices such as but not limited to occupancy-detecting light fixtures. The gateway device may process this information in conjunction with a number of other tools and services such as but not limited to a cloud computing service or a data visualization application to provide space utilization information on the basis of the observed occupancy detection transmissions.

In a number of embodiments, the architecture of the gateway device to cloud interface may be based on an IoT Hub service. The IoT Hub service may support bi-directional communications between IoT devices and the cloud. Gateway to cloud communications may occur according to messaging patterns such as but not limited to device to cloud telemetry, request-response messages to control devices from the cloud, and file upload from devices. In addition, IoT device provisioning, monitoring, OTA, and management services may provide either individual, group, or fleet gateway or connected device operations. The interface between the IoT Hub and IoT devices may support a number of platforms, languages, and message standards. The IoT Hub service provide the library code and examples required to quickly integrate an IoT device with the IoT Hub service. In this way, flexibility to ensure that current and future designs can interoperate with the system may be achieved.

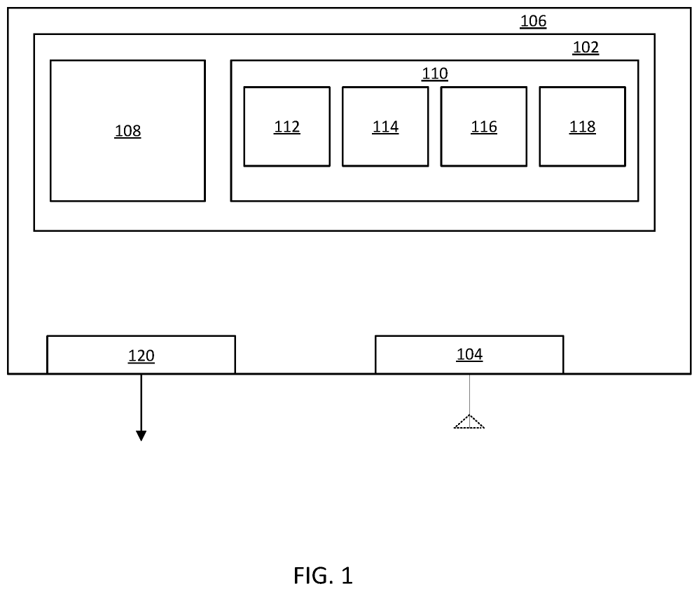

FIG. 1 is a block diagram of a gateway device 106 incorporating a transmission eavesdropping circuit 112 according to a number of embodiments. The gateway device 106 includes a processing circuit 102. The processing circuit 102 may include a plurality of electrical and electronic components that provide power, operation control, and protection to the components and modules within the processing circuit 102. In the example illustrated, the processing circuit 102 may include, among other things, an electronic processor 108 (such as a programmable electronic microprocessor, microcontroller, distributed or local multi-processor, or similar device), a memory 110 (for example, non-transitory, machine readable memory), an input/output interface 120 (such as an ethernet port), and a communication interface 104 (such as a wireless transceiver).

In the embodiment shown, the memory 110 of the gateway device 106 includes a transmission eavesdropping circuit 112, a transmission analysis circuit 114, a state and event data generation circuit 116, and a data transmission circuit 118. The transmission eavesdropping circuit 112 is configured to monitor or observe the data transmissions of connected devices to one another. For example, the transmission eavesdropping circuit 112 may be configured to detect occupancy detection data collected by an occupancy-detecting connected lighting device when it is transmitted from the connected lighting device to another connected device. The transmission detect such transmissions via the transmission eavesdropping circuit 112 as raw data, determines the source and destination of each transmission via the transmission analysis circuit 114, and copies the transmission to the memory 110 without interrupting the transmission as it travels between the devices. This process of detecting and copying transmissions or data may be referred to simply as “observing” or “monitoring” transmissions or data herein.

A transmission analysis circuit 114 of the gateway device 106 is configured to analyze the transmission data observed and copied by the transmission eavesdropping circuit 112. For example, the transmission analysis circuit 114 may identify a message type of each transmission and associate each transmission with a sending device and receiving device. The transmission analysis circuit 114 may also determine a timestamp of observance for each observed transmission, and a coded transmission number for each transmission. In this way, the transmission analysis circuit 114 can be used to identify errors in observed transmission sequences and determine whether any transmissions in a sequence were dropped.

A state and event generations circuit 116 may generate an occupancy state or event based on the analyzed transmission data. Occupancy events may be messages or data generated by a gateway device may indicate an occupancy state transition (e.g., occupied to vacant, or vacant to occupied, inflow, outflow, etc.) for each occupancy-detecting connected device. The generated event messages or data may be formatted similar to CSV files or tables but may also take other forms. The occupancy events themselves may represent all changes for individual occupancy-detecting connected devices over time. By combining the occupancy events with the configuration of the connected device, communication hub, or area as described herein, the occupancy state transitions for any zone of an area can be computed. In some cases, the generation of occupancy, computation of occupancy transitions, and update of internal data model events or business intelligence model may be the second step in a data processing pipeline facilitated by a connected gateway device and occupancy-detecting connected devices as disclosed herein.

In a number of embodiments, occupancy states may be periodically generated by a gateway device to indicate a snapshot of occupancy events observed by occupancy-detecting connected lighted devices in an area. The occupancy state may contain items such as but not limited to an occupancy percent, an on-state indicator, or configuration of each connected device such as but not limited to a dimming level for a connected light fixture. This state may be periodically evaluated by the gateway device 106 for all connected devices for a particular duration, and an occupancy state message may be generated by the gateway device 106. For example, the gateway device 106 may generate an occupancy value representing an average percentage of the area that was occupied during the time period, or an occupancy value representing a time period during which the area was occupied. As a non-limiting example, if occupancy was sensed by at least one occupancy-detecting connected device for only two minutes of a five-minute sensing interval, then the occupancy value generated by the gateway device may be a an occupancy percent value indicating 40%.

A data transmission circuit 118 of the gateway device 106, is configured to transmit the generated occupancy states or occupancy events to a cloud computing service for analysis via communication interface 104. In some embodiments, data transmission circuit 118 is configured to transmit the generated occupancy states or occupancy events to the cloud computing surface via input output interface 120.

In a number of embodiments, occupancy state may be periodically evaluated by the gateway device 106 with the goal of a good balance between network traffic and data resolution. For example, the gateway device 106 may evaluate an occupancy state of a particular area or zone once per minute. In this way, time-binned occupancy state data may be produced. Time-binned occupancy state data may be easy to analyze and aggregate alongside other data without greatly increasing or overloading the processing bandwidth of the disclosed system. In addition, doing so may allow the gateway device to perform much of the connected device transmissions processing at the edge (e.g., locally) thus reducing cloud costs. Additionally, occupancy states may be computed from a log of observed transmissions at a cloud computing service.

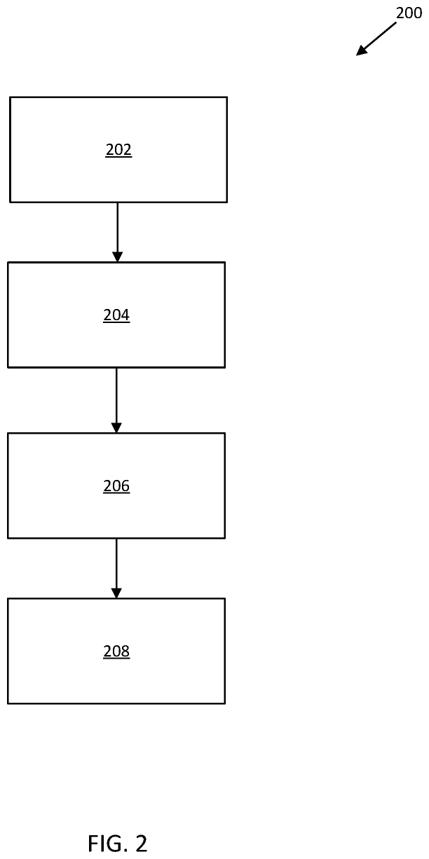

FIG. 2 is a flow diagram for a gateway device eavesdropping on messages transmitted between connected devices. In the embodiment shown, a gateway device may be constructed and arranged to perform a steady state ingest of transmissions from connected devices, transmission analysis, event and state data generation, and transmit the ingested items to a central computing device such as but not limited to a cloud computing service. A gateway device may continuously observe or monitor transmissions from connected devices to one another or to a communications hub device such as a port module. The transmissions may be observed end to end, thereby forming a stream of transmissions. As noted above, the gateway device may copy these transmissions to a memory as it detects them. The gateway device may then parse the copied transmissions into packets that may be transmitted to a message generator for communication via an IoT hub to an external system such as but not limited to a cloud computing or storage service.

At block 202, a gateway device may monitor the transmissions of connected devices. The gateway device may be constructed and arranged to monitor or observe the transmissions of connected devices such as but not limited to occupancy-sensing lights and analyze the transmissions to derive useful data about a premise. The connected devices may already be installed and operating in a particular premise before the gateway device is in place. The connected devices may be in over-the-air communication with one another, or with a hub for connected devices such as a port module, a bridge device, or an area management device. The gateway device may be placed in general proximity to the occupancy-detecting connected devices and observe or monitor their occupancy-related transmissions in a non-obstructive manner. That is, the gateway device may merely eavesdrop on the transmissions of the connected devices without affecting their transmission. For example, a gateway device may monitor unprocessed transmissions as they are transmitted from occupancy-sensing lights to a port module. That is, the raw data of the transmission may be detected by the gateway device, copied by the gateway device, and processed by gateway device before being transmitted to a cloud computing service. The gateway device may be configurable with respect to sampling rate, sample period, sample start time, sample end time, sample start date, sample end date, and the like. The gateway device may capture these transmissions in a seamless chronological stream for processing, but this is not the case in every implementation. For example, the gateway device may observe transmissions on a near constant basis to form a stream or may implement a periodic copy operation every 270 seconds in accordance with a timeout period set on the connected devices.

At block 204, a protocol parser of the gateway device may analyze an incoming stream of observed transmissions from connected devices and parse the steam into packets. The gateway device may identify and record periods of data loss or corruption to ensure the integrity of the stream of transmission between the connected devices. Detection of data loss in the transmission stream may serve in maintaining the integrity of the data pipeline and may be accomplished by the gateway device through a number of techniques including tracking a connected device transmission sequence number associated with each connected device.

At block 206, the packets, are forwarded to a state and event data generation circuit for formatting into a cloud message which may be in turn forwarded to an IoT publisher for delivery to the cloud. For example, a periodic state monitor of the gateway device may compute a state for all connected devices for each period and forward it to the state and event generation circuit, where it is formatted into occupancy event messages or occupancy state messages interpretable by a cloud computing system. Similarly, when an occupancy event occurs (e.g., a change to occupancy is detected) the state and event generation circuit may generate an appropriate message for communicating the occupancy event to an external system via the IoT hub.

At block 208, the IoT hub may repeatedly or periodically communicate the device state and event data it receives from the state and event generation circuit to an external system such as a cloud computing system for logging or analysis. The gateway device may transmit the device state and event data based on the order in which the pertinent transmissions were observed by the gateway device. In some embodiments, complete, unprocessed, observed transmissions are copied and sent to the cloud computing system in the order observed. The format of the transmissions may be a record containing various message fields and/or an array of octets. For example, the observed transmission that are communicated to the cloud computing system may be a complete record of the port module's incoming and outgoing messages (e.g., the port module's bus activities). This complete record may include an indication that the record is missing messages. Any data communicated to the cloud may first be formatted as or inserted into a cloud message by the gateway device and communicated to the cloud computing system.

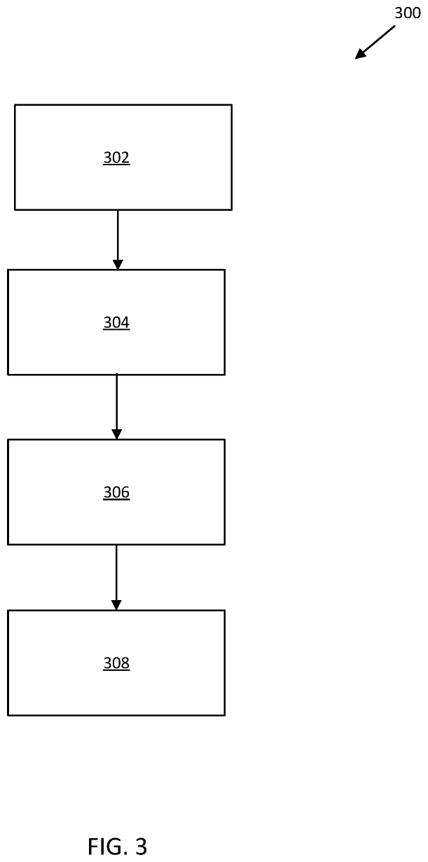

FIG. 3 depicts a flow diagram for receipt and analysis of event and state data by a cloud computing system. The cloud computing system may include a system such as a data lake system or a globally distributed scalable database. The cloud computing system may also include a distributed processing system.

At block 302, the cloud computing system receives the cloud message communicated to it by the gateway device.

At block 304, the cloud computing system extracts the analyzed and formatted device state and event data, or copies of the unprocessed, observed, transmissions from the cloud message.

At block 306, the cloud computing system analyzes the data received from the gateway device. The cloud computing system analyzes the received data to produce visual data from the state and event data, and for system maintenance or tuning reasons such as identifying dropped transmissions and identifying faults in equipment. For example, the cloud computing system may analyze the occupancy state and event data to produce a plurality of timestamped heat maps representative of customer movement and concentration and movement in a monitored area of a retail store at particular times during the day. Additionally, the cloud computing system may monitor the gateway device itself to ensure its reliability, and to ensure that the disclosed system provides a constant and accurate stream of transmissions, so that problems may be quickly identified and appropriate staff alerted to restore operation as soon as possible.

At block 308, the cloud computing system enters analyzed data in a storage system accessible to a business analytics application. For example, the analyzed data may be store in a cloud storage system and accessed by a business analytics application exhibiting legitimate credentials. The business analytics application may then populate a dashboard that presents the analyzed data in a manner that visually depicts relationships between different sets of analyzed data for a user. This populated dashboard may be displayed to a user via an electronic display (e.g. desktop computer or mobile device).

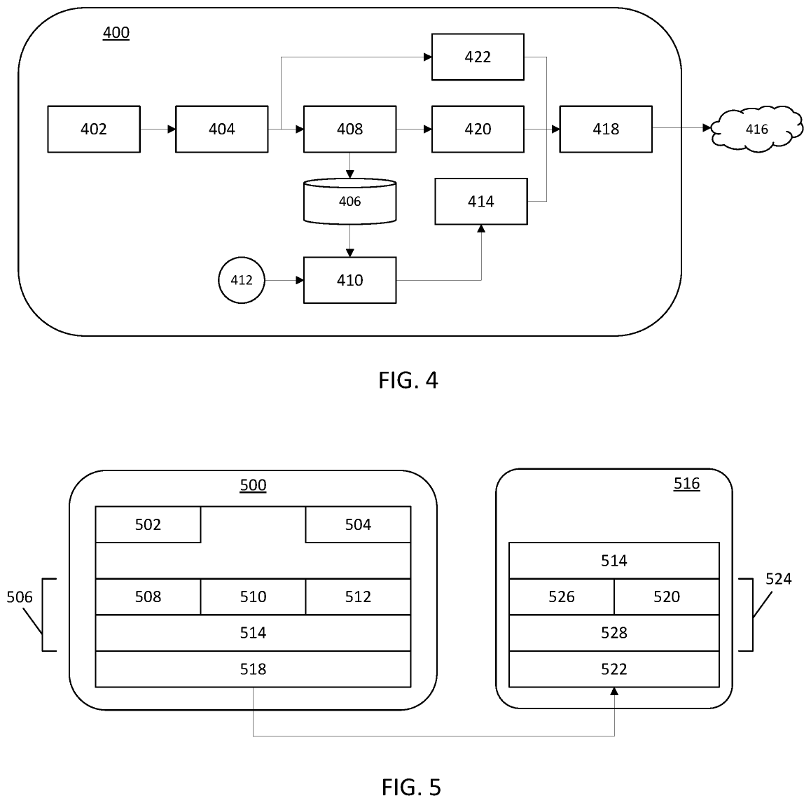

FIG. 4 depicts a flow diagram for capture, processing, and secure communication of connected device transmissions by a gateway device 400 according to a number of embodiments.

A serial capture executable 402 of the gateway device 400 may be configured to continuously monitor or observe transmitted data available to a wireless transceiver of the gateway device 400, as described above. A protocol parser executable 404 may be configured to determine the protocol of observed data and then parse the observed data according to its determined protocol. For example, if the serial capture executable 402 observes data transmitted by a connected lighting device to another connected lighting device, the protocol parser executable 404 determines that the protocol of the observed data is it connected lighting device command. The protocol parser executable 404 then parses the observed data as if it were or connected lighting device command. accordingly, the constituent parts of a connected device lighting command are individually identified by the protocol parser executable 404 and passed to a data model updater executable 408.

The connected devices may form a mesh network. The gateway device 400 maintains a data model 406 of this network. The data model updater executable 408 of the gateway device updates the data model 406 based on the parsed version of each observed transmission, viewing the observed transmissions as device events. For example, if a first occupancy-detecting connected device transmits data indicating a detected occupancy of the area covered by its occupancy sensor(s), the data model updater executable 408 updates the data model 406 to indicate that the area in which the occupancy-detecting connected device is positioned experienced an occupancy event (e.g. a change from vacant to occupied) at the time the occupancy detecting connected device transmitted the data indicating the occupancy. This type of update to the data model 406 may occur in rapid succession and for each connected device in the network based on observed transmissions.

The data model 406 may indicate which areas of a pertinent premise are occupied and when. The data model 406 may also comprise a record of updates, thereby indicating a timeline of changes to occupancy on the premise that serves as a basis for the state monitor executable 410 to generate a record of events that lead to the current state of the data model 406. A state monitor executable 410 may be configured to periodically produce a snapshot of the data model 406 according to the period of a time keeping device 412. In some cases, the state monitor executable 410 may watch the data model 406 for changes and produce a snapshot in response to a detected change in the data model 406. For example, the data model 406 may be an occupancy model, and the state monitor executable 410 may monitor the data model 406 for changes in occupancy states in any areas of a particular premise represented by the data model 406. In such a case, the state monitor executable 410 may produce a snapshot in response to a detected change in the data model 406. The snapshot maybe processed by a device state generator executable 414 to produce a packet for publishing to a cloud computing system 416 by an IoT publisher 418. Similarly, a device event generator 420 may analyze data communicated to it by the data model updater executable 408, and a message generator executable 422 may analyze the messages parsed by the protocol parser executable 404, and produce packets for publishing to the to the cloud computing system 416. For example, the protocol parser executable 404 may determine that the observed data, such as mesh network metadata, does not justify an update to the data model 406. In such a case, the message generator executable 422 may produce a mesh network metadata packet for publishing to the cloud computing system 416 via the IoT publisher 418. The IoT publisher 418 may generate a cloud message and insert packets into the cloud message. The IoT publisher 418 may then publish the cloud message to the cloud computing system 416 according to a cloud communication protocol.

FIG. 5 depicts a collection of gateway device applications 506 and cloud computing system applications 524 that ensure communication between the gateway device 500 and the cloud computing system 516 is robust and reliable.

As noted above, the gateway device 500 may include a serial capture executable 502. The serial capture executable 502 may be used by the gateway device 500 in updating a data model 504 based on transmitted data observed by the gateway device 500 via the serial capture executable 502—the data model 504 representing and network of connected devices monitored by the gateway device 500. A gateway application 506 may include an IoT method handler 508, an IoT telemetry component 510, a gateway IoT digital twin 512 or gateway data model, and an IoT client 514.

In the embodiment shown, the IoT method handler 508 may be configured to interpret method calls submitted to the gateway device 500 from external, connected devices, or from cloud computing system 516. The IoT telemetry component 510 may be configured to packetize data received from connected devices for transmission to the cloud computing system 516 (as described above). The gateway IoT digital twin 512 may maintain a digital model of a mesh network of connected devices, in some cases including the gateway device 500, that indicates the current operating state of the electrical and software components of the mesh network at least for optimization and troubleshooting purposes. This gateway IoT digital twin 512 may also be shared with the cloud computing system 516, or a copy may be separately maintained by the cloud computing system 516 for analytics purposes as a cloud IoT digital twin 520 or cloud data model. For example, the cloud computing system 516 may analyze the cloud IoT digital twin 520 and produce an analytics dashboard indicating occupancy events and states throughout a retail store over the course of a day, according to the methods described above. The IoT client 514 may be configured to transmit data such as occupancy event packets, occupancy state packets, unprocessed transmission packets, or digital twin update packets to the cloud computing system 516.

The gateway device 500 and cloud computing system 516 may also be associated with an internet protocol (IP) addresses 518, 522 for communicating with connected devices and the cloud computing system 516. The cloud computing system 516 may also maintain records of data streams 526 received at an IoT hub 528 from the gateway device 500.

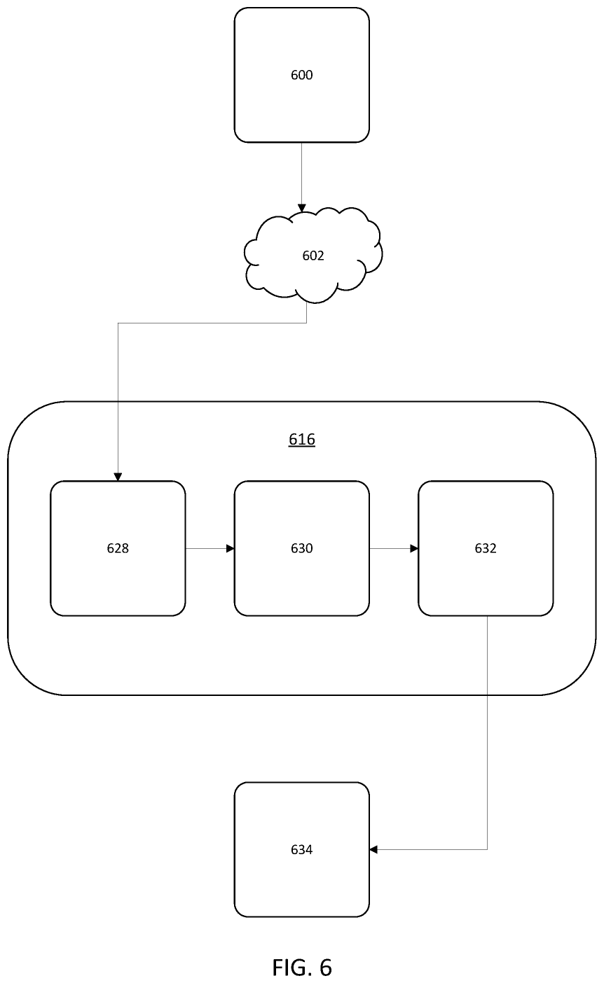

Referring now to FIG. 6, gateway device 600 may communicate observed transmissions via a network 602 (e.g. the internet) to a cloud computing system 616 where the observed transmissions may travel through an IoT hub 628 and be analyzed by a stream analytics system 630. The analyzed transmissions may then be stored in a data storage system 632 such as a data lake system or a globally-distributed scalable database for access and visualization as space utilization information via a business intelligence application 634 on a capable device such as but not limited to a desktop computer or a mobile device.

The disclosed transmission observation may have multiple benefits. For example, during the deployment and testing of the disclosed system, it may be advantageous to have the raw data which can be examined and analyzed for optimization purposes. Additionally, the complete record of a connected device communication hub such as a port module may be helpful in exploring aspects of preventative maintenance, failure detection, and real-world system behavior. Continuous transmission cure may be enabled or disabled from the cloud. Accordingly, the implementation of observing and copying raw transmission may be made simple yet robust and may mitigate temporal considerations from a gateway device input perspective.

In a number of embodiments, the gateway device does not maintain a local data model and may communicate a stream of observed transmissions as cloud messages to the cloud computing system for analysis. In such embodiments, the cloud computing system may update a data model based on cloud messages received from the gateway device.

The embodiment(s) described above and illustrated in the figures are presented by way of example only and are not intended as a limitation upon the concepts and principles of the present disclosure. As such, it will be appreciated that variations and modifications to the elements and their configurations and/or arrangement exist within the spirt and scope of one or more independent aspects as described.

What is claimed is:

1. A product comprising:
a gateway device constructed and arranged to monitor a transmission of a connected device in a device network, the gateway device including
a memory;
a communication interface;
an electronic processor configured to
monitor the transmission via the communication interface;
determine a protocol of transmission;
parse the transmission according to its determined protocol to produce a parsed transmission;
update a data model of the device network based on the parsed transmission; and,
store the data model in the memory.

2. The product of claim 1 wherein the connected devices include occupancy-detecting lighting devices, and the transmission includes occupancy detection data.

3. The product of claim 1 wherein the electronic processor is further configured to
produce an occupancy event based on the parsed transmission.

4. The product of claim 3 wherein the electronic processor is further configured to
update the data model in based on the parsed transmission.

5. The product of claim 4 wherein the electronic processor is further configured to
produce an occupancy state based on the data model.

6. The product of claim 5 wherein the electronic processor is further configured to produce a cloud message based at least upon the occupancy state and to transmit the cloud message, via the communication interface, to a cloud computing system.

7. A method of using gateway device to monitor transmissions between connected devices in a device network comprising:
monitoring, by a communication interface of the gateway device, a transmission of a connected device via the communication interface;
determining, by an electronic processor of the gateway device, the transmission to produce a parsed transmission;
parsing, by the electronic processor, the transmission to produce a parsed transmission;
updating, by an electronic processor, a data model of the device network based on the parsed transmission; and,
storing, by the electronic processor, the data model in a memory.

8. The method of claim 1 wherein the connected devices include occupancy-detecting lighting devices, and the transmission includes occupancy detection data.

9. The method of claim 1 further comprising
generating, by the electronic processor, an occupancy event based on the parsed transmission.

10. The product of claim 3 further comprising
updating, by the electronic processor, the data model in based on the parsed transmission.

11. The product of claim 4 further comprising
generating, by the electronic processor, an occupancy state based on the data model.

12. The product of claim 5 further comprising
generating, by the electronic processor, a cloud message based at least upon the occupancy state; and,
transmitting, by the electronic processor via the communication interface, the cloud message to a cloud computing system.

13. A system comprising:
a cloud computing system;
a gateway device constructed and arranged to monitor a transmission of a connected device in a device network, the gateway device including
a communication interface;
an electronic processor configured to
monitor the transmission via the communication interface;
determine a protocol of transmission;
parse the transmission according to its determined protocol to produce a parsed transmission;
produce a cloud message based on the parsed transmission; and,
transmit the cloud message to the cloud computing system.

14. The system of claim 13 wherein the cloud computing system is configured to
extract the parsed transmission from the cloud message, and
store the parsed transmission.

15. The system of claim 13 wherein cloud computing system is further configured to
update a cloud data model of the device network based on the parsed transmission.

16. The system of claim 13 wherein the electronic processor is further configured to
update a gateway data model of the device network based on the parsed transmission.

17. The system of claim 16 wherein the electronic processor is further configured to
produce an occupancy state based on a data model, and
produce the cloud message based additionally on the occupancy state.

18. The system of claim 16 wherein the electronic processor is further configured to
produce an occupancy event based on the data model, and
produce the cloud message based additionally on the occupancy event.
